(19) United States
(12) Patent Application Publication
(10) Pub. No.: US 2013/0190203 A1
(43) Pub. Date: Jul. 25, 2013

(54) Reporting And Self-Decontaminating Articles For Individual Hazard Detection And Protection

(71) Applicant: SRC, Inc, North Syracuse, NY (US)

(72) Inventors: Adam J. Lowe, Syracuse, NY (US); Christopher Raddell, Baldwinsville, NY (US); Jesse Taylor, Baldwinsville, NY (US)

(73) Assignee: SRC, INC., North Syracuse, NY (US)

(21) Appl. No.: 13/747,699

(22) Filed: Jan. 23, 2013

Related U.S. Application Data
(60) Provisional application No. 61/589,974, filed on Jan. 24, 2012.

(51) Int. Cl. G01N 27/327

(52) U.S. Cl. CPC G01N 27/3276
USPC 506/9; 506/39

(57) ABSTRACT

Methods, systems, and devices for the self-detection and/or self-decontamination of chemical, biological, radiological, and/or nuclear hazards, threats, and contaminants. The self-detection system preferably uses aptamers functionalized to an electronic system to sense CBRN threats. The aptamers are functionalized directly to a conductive surface such as a noble metal coated fiber or other conductive fiber strand. The self-decontamination system is preferably in communication with the self-detection system and responds to the detection of a CBRN agent by switching to a decontamination state, such as becoming absorbent or releasing an anti-CBRN agent such that it can neutralize the threat. In a preferred embodiment, the system is worn by a user.

### CROSS-REFERENCE TO RELATED APPLICATIONS

This application claims priority to U.S. Provisional Patent Application Ser. No. 61/589,974, filed on Jan. 24, 2012 and entitled “Self-Reporting and Self-Decontaminating Clothing for Individual CBRN Protection,” the entire disclosure of which is incorporated herein by reference.

### BACKGROUND OF THE INVENTION

1. Field of the Invention

The present invention relates to the detection and decontamination of chemical, biological, radiological, and/or nuclear hazards, and more specifically, to clothing or device worn by a user which automatically detects and optionally decontaminates the chemical, biological, radiological, and/or nuclear hazard.

2. Description of the Related Art

There is an increasing demand for assays for the detection and quantitative identification of chemical, biological, radiological, and/or nuclear (“CBRN”) hazards across a broad range of disciplines, including defense, food safety, homeland security, and medical diagnostics. While there is existing technology for the detection and quantitative identification of chemical and biological hazards, these sensors are generally large, bulky, and/or slow sensor systems that require considerable time and effort to utilize or to move from one location to another. Accordingly, there is a continued need for fast, efficient, and portable sensor systems for chemical and biological hazard detection.

Aptamers are single-stranded oligonucleic acid or peptide molecules that bind to a specific target molecule. The target molecule can be, for example, a protein, nucleic acid, cell, or tissue, among many others. While some aptamers are naturally occurring, most are designed for a specific target. Due to the high affinity and specificity for their target(s) of interest, aptamers are increasingly used as diagnostic reagents. Accordingly, aptamers are a potential component of sensors for the detection and quantitative identification of chemical and biological hazards.

Once a CBRN hazard or contaminant is detected, the state-of-the-art in filtration devices for contaminant removal is devices which contain activated carbon. While activated carbon technology is effective, it typically requires a large bed of adsorption media. These large adsorption bed volumes require large amounts of space, and often result in significant pressure drops across the filter bed. A large pressure drop across the filter bed, in turn, can significantly impact the capital cost to build the system as well as the operating costs due to required over-sizing of many components. Also, in an activated carbon system there is no detoxification of air, only the removal of offending species from the air. The toxic species remain toxic and the contaminated activated carbon bed becomes toxic itself, thereby requiring remediation, including specialized and expensive waste and detoxification expenses. Innovative technologies are therefore required for both the detection and decontamination of CBRN hazards and contaminants.

### BRIEF SUMMARY OF THE INVENTION

It is therefore a principal object and advantage of the present invention to provide a method, device, and/or system for the detection and decontamination of CBRN hazards and contaminants.

It is another object and advantage of the present invention to provide a method, device, and/or system for the detection and decontamination of CBRN hazards and contaminants using a wearable and portable device or article of clothing.

Other objects and advantages of the present invention will in part be obvious, and in part appear hereinafter.

According to one embodiment, a method of detecting a target in a sample using an article held or worn by a user, the method comprising the steps of: (i) contacting the article with the sample, the article comprising a target sensor and a decontamination element, wherein said target sensor comprises a plurality of aptamers functionalized to a conductive surface, and wherein said target sensor is in communication with said decontamination element; (ii) detecting, by the target sensor, the target in the sample; (iii) generating, by the target sensor, a detection notification signal in response to detection of the target in the sample; (iv) activating the decontamination element in response to the notification signal; and (v) decontaminating, by activation of the decontamination element, the detected target.

According to an aspect, the conductive surface is a conductive fiber strand, or a fiber coated at least partially in metal.

According to another aspect, the plurality of aptamers form part of a conductive hydrogel, wherein an electrical property of the hydrogel changes in response to detection of the target in the sample.

According to one aspect, the target is a chemical, biological, or radiological agent.

According to another aspect, the article further comprises a transmitter in communication with the target sensor.

According to yet another aspect, the method further comprises the step of transmitting the detection notification signal in response to detection of the target in the sample.

According to another aspect, the article is an article of clothing or a handheld device.

According to a further aspect, the article comprises a plurality of different types of target sensors and a plurality of different types of decontamination elements, each of the plurality of different types of target sensors in communication with a corresponding different type of decontamination element. According to one embodiment, each different type of target sensor generates a unique detection notification signal, and each unique detection notification signal activates a type of decontamination element corresponding to the unique detection notification signal.

According to one embodiment, the target sensor comprises one or more aptamers functionalized to a conductive surface.

According to another aspect, a system for detecting a target in a sample using an article held or worn by a user, the system comprising: (i) a sample, the sample potentially comprising the target; and (ii) an article, the article comprising a microprocessor, a target sensor, and a decontamination element, wherein said microprocessor, said target sensor, and said decontamination element are in communication, and wherein said target sensor comprises a plurality of aptamers functionalized to a conductive surface; wherein the target sensor is adapted to detect a target in the sample, if the target is present in the sample, and where the target sensor is further adapted to generate a detection notification signal in response to detection of the target in the sample; wherein the microprocessor is adapted to receive the generated detection notification signal and, in response to the received detection notification signal, activate the decontamination element; wherein the activated decontamination element decontaminates the detected target.

According to an aspect, the conductive surface is a conductive fiber strand, or a fiber coated at least partially in metal.

According to another aspect, the plurality of aptamers form part of a conductive hydrogel, wherein an electrical property of the hydrogel changes in response to detection of the target in the sample.

According to another aspect, the target is a chemical, biological, or radiological agent.

According to a further aspect, the system further comprises a transmitter in communication with the microprocessor, wherein the microprocessor is adapted to send a transmission signal to the transmitter in response to the received detection notification signal, and further wherein the transmitter is adapted to transmit an alert in response to the transmission signal. According to one embodiment, the transmitter is adapted to wirelessly transmit the alert.

According to one aspect, the article is an article of clothing or a handheld device.

According to another aspect, the article comprises a plurality of different types of target sensors and a plurality of different types of decontamination elements, wherein each different type of target sensor is adapted to generate a unique detection notification signal, and wherein each unique detection notification signal activates a type of decontamination element corresponding to the unique detection notification signal.

According to a further aspect, a system for detecting a target in a sample using an article held or worn by a user, the system comprising: (i) a sample, the sample potentially comprising the target; and (ii) an article, the article comprising a microprocessor, a target sensor, a decontamination element, and a wireless transmitter, wherein said microprocessor, said target sensor, said decontamination element, and said transmitter are in communication, and wherein said target sensor comprises a plurality of aptamers functionalized to a conductive surface; wherein the target sensor is adapted to detect a target in the sample, if the target is present in the sample, and wherein the target sensor is further adapted to generate a detection notification signal in response to detection of the target in the sample, and further wherein the target sensor comprises one or more aptamers functionalized to a conductive surface; wherein the microprocessor is adapted to receive the generated detection notification signal and, in response to the received detection notification signal, activate the decontamination element; wherein the activated decontamination element decontaminates the detected target; wherein the microprocessor is further adapted to send a transmission signal to the wireless transmitter in response to the received detection notification signal, and further wherein the wireless transmitter is adapted to transmit an alert in response to the transmission signal.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic representation of a self-reporting, self-decontaminating article according to an embodiment;

FIG. 2 is a schematic representation of a self-reporting, self-decontaminating article according to an embodiment; and

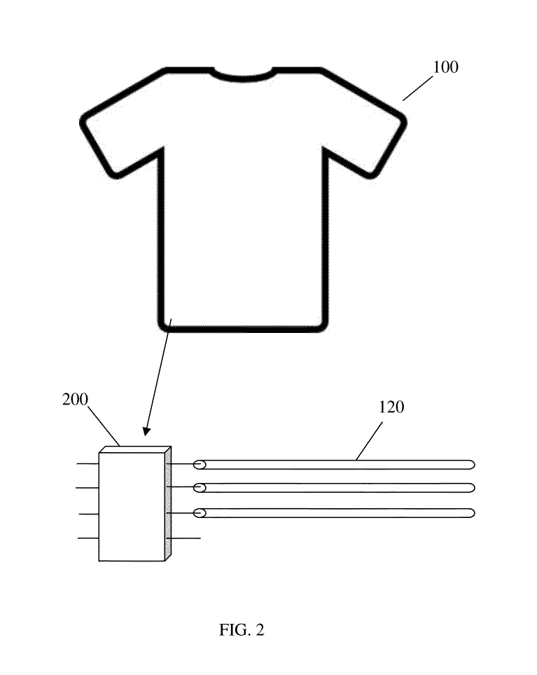

FIG. 3 is a schematic flowchart of a method for self-reporting and self-decontaminating.

### DETAILED DESCRIPTION OF THE INVENTION

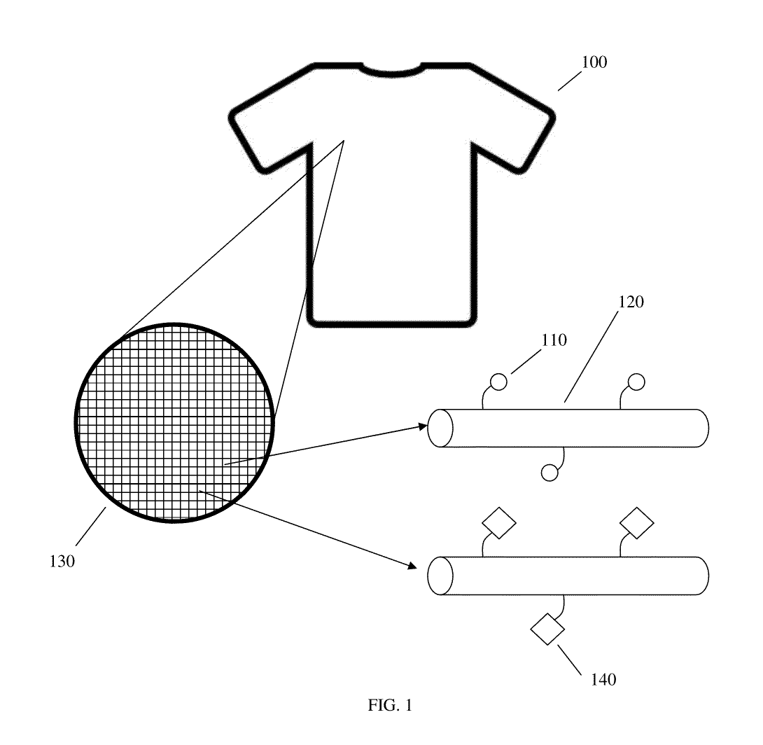

A detection and self-decontaminating tool, device, or article of clothing provides numerous benefits, including minimization of the spread of the harmful materials and decreased contamination of any system where the device is installed. These novel systems allow for significantly improved reaction time to a potential release of harmful materials thereby saving lives and decreasing total remediation time, effort, and costs. Referring now to the drawings, wherein like reference numerals refer to like parts throughout, there is seen in FIG. 1 a schematic drawing of a detection and self-decontaminating article 100 worn by a user which automatically detects and optionally decontaminates target chemical, biological, radiological, and/or nuclear hazard(s), according to one embodiment of the method. Although detection and self-decontaminating article 100 is depicted as an article of clothing in FIG. 1, particularly a shirt, the article is not limited to either an article of clothing such as a shirt. For example, article 100 can be any other article of clothing, including but not limited to shirts, pants, dresses, undergarments, gloves, shoes or boots, uniforms, or hats, among many others. In addition, article 100 can be a non-clothing item such as protective gear, air tanks, handheld devices such as PDAs, cellphones, or computers, among many, many other non-clothing items.

Self-Detection

The detection mechanism in many existing sensors involves changes in properties such as conductivity, absorbance, luminescence, fluorescence and the like. The difficulty faced by these sensors, however, include the small magnitude of the signal event which can make detection of the signal difficult or affect the selectivity or make the sensor subject to false positive readings. The self-detection system described herein preferably uses aptamers functionalized to an electronic system to sense CBRN threats, hazards, and contaminants. The aptamers can be, for example, protein or nucleic acid aptamers known in the art, or protein or nucleic acid aptamers created especially for this system.

For example, the aptamer can be created using any of a number of known methods in the art for isolating, identifying, or creating aptamers. While some aptamers are known to occur in nature, there are several methods used to create aptamers with high specific affinity for a target ligand such as a chemical or biological agent. The SELEX (systematic evolution of ligands by exponential enrichment) method, for example, uses multiple rounds of in vitro selection to select—and then selectively evolve—a suitable aptamer from a large library of randomly generated oligonucleotide sequences.

To enable detection, the aptamers 110 are preferably functionalized directly to a conductive surface such as a noble metal coated fiber 120 or other conductive fiber strand. Aptamers may also be functionalized with electrically or optically conductive components such as carbon nanotubes, metal nanoparticles, or electrically conductive chemical groups such as Ferrocene or compounds containing extended conjugation. They can be attached to a surface using any method of functionalization known in the art, for example. Further, the aptamers can be attached by themselves, or with a stabilizing component/agent such as a sugar, trehalose, PEG, or any other stabilizer.

According to one embodiment, the aptamers form a sensor 130. The sensor can be any size depending on the requirements of the system, and can be distributed throughout the fabric or placed in a single location. Further, there can be anywhere from one sensor to hundreds or thousands of sensors located in or on an article. In one embodiment, the sensing node can be placed on or embedded within a fabric such as a uniform, hat, gloves, shirt, pants, undergarment, belt, boot, shoe, or mask, among many other options. In another embodiment, the sensing node can be placed on or embedded within a wearable—but non-clothing—element such as a rank insignia, a warfare patch, a material patch for a swipe test, a bracelet, or a necklace, among many other options. In yet another embodiment, the sensing node can be placed on or embedded within an external element or tool such as a shovel, vehicle, or other device which will be used in a manner or location that could possibly come in contact with a CBRN threat. For example, the sensor can be placed on the outside of a vehicle that is traveling through an area believed to be a high threat area such that it can warn individuals inside the car that the vehicle exterior has encountered a CBRN threat.

In a specialized system, binding of specific CBRN will result in a specific electrical change. The specific electrical change, in turn, can be used to trigger a specific notification and/or decontamination. In this way, the system can detect, alert, and decontamination in response to individual CBRN threats. For example, the system can be designed to specifically alert the user whenever a certain radiation is detected, or when a certain chemical agent is detected, among many other types of specific detection. As one example, the system can be designed to send a blue signal when a chemical agent is detected. As another example, the system can be set up to audibly announce the CBRN agent detected, such as triggering a speaker to say the words “ALERT, RADIATION DETECTED” when the system detects radiation. Further, the system can be designed to release a certain decontamination measure when it detects a certain CBRN threat.

When a target CBRN contaminant binds the aptamer, an electrical signal change would then be perceived. Indeed, aptamers could also be functionalized onto the surface as part of a conductive hydrogel which would change electrical properties when a threat binds. The electrical signal change can optionally be facilitated by a “chain reaction” whereby the aptamers are engineered to significantly change the state of the hydrogel under initial threat binding. The electrical signal change can then be harnessed for downstream processes. For example, the detection can trigger a notification system and/or a decontamination system. For instance, once the system detects a CBRN threat, hazard, or contaminant, the system can warn the wearer or user through a variety of methods, any of which can be initiated using an electrical signal change. This can include a color change (such as changing the color of the clothing or article, or sending a signal to change the color of another wearable or visualized component) or other visual notification, an audible signal or other audible notification, or any other form of notification that will alert the wearer or user that a CBRN threat, hazard, or contaminant has been detected by the system.

As one embodiment, article 100 includes controller chip 200, which is electrically or conductively in communication with the aptamers, for example through fiber 120, although other methods are possible. Chip 200 can be any controller, microprocessor, or other logic device that detects and processes incoming signals. For example, chip 200 can be a microprocessor programmed to initiate a response—such as a decontamination process (described elsewhere herein) or a notification—upon detection of a target hazard by an aptamer in the sensor. Further, as another example of a notification, once the system detects a CBRN threat, hazard, or contaminant the system can communicate the detection to a remote location, such as a command or control center, preferably directed by controller chip 200. This can be accomplished in a wired or wireless fashion using any method known in the art. As one example, the system can communicate to a local receiver located in another portion of the article 100, or located immediately nearby such as in a smartphone, computer, or other detection device.

Self-Decontamination

Once the system detects a CBRN threat, hazard, or contaminant, the system can then optionally trigger decontamination of that threat. For example, the electrical change could be received by chip 200, comparing reference strands to “sensing” strands. If a threat is sensed, this chip would activate a secondary system to activate microcapsules containing decontaminating agents. Other methods of detection, processing, and decontamination are possible.

The decontamination microcapsules 140, shown in FIG. 1, can be embedded in or on the clothing, tool, item, or external device using any known method, device, or system. The microcapsules can be formed of, for example, organic materials, such as polymeric species, or inorganic materials, such as oxides, although this list is not meant to be comprehensive. There are a wide variety of microencapsulation methods and techniques, and any one of these methods may be used to create, or encapsulate material to form, microcapsules. Further, the clothing, tool, item, or external device may comprise just one type of microcapsule, or comprise many different types of microcapsules. A system designed to decontamination multiple threats may contain many types of decontamination agents.

The microcapsules preferably encapsulate a decontamination agent initially located inside each microcapsule. The decontamination agent is, for example, inserted inside the formed microcapsule, or the microcapsule can be formed around the decontamination agent. According to one embodiment, decontamination agent is a highly reactive compound that quickly and effectively neutralizes a target toxin, contaminant, or other molecule or agent. According to one embodiment, decontamination agent is chosen from, but not limited to, one or more commercial products and/or a combination of products such as Spilfyter® Decontamination Solution 2, Supertropical bleach, EasyDecon®, QAC Decontamination Solution, M100 Sorbent Decontamination, and/or L-Gel, among many other known decontamination and/or trapping agents. According to another embodiment, decontamination agent is a commercial product, or a proprietary product or mixture. According to yet another embodiment, the decontamination agent located inside a single microcapsule is a mixture of two or more agents targeting one or more toxic compounds or materials.

The microcapsules can also comprise a remotely triggerable agent which is triggered by a remote trigger agent. For example, the remotely triggerable agent can comprise, among other things, carbon nanotubes, photosensitive organic molecules, metal oxides and/or metal particles. Accordingly, the remotely triggerable agent can be activated by a remote trigger agent such as light, electrical potential, pressure, temperature, or other methods sufficient to induce the release of decontamination agent. The remote location may be a command or control center that has detected a CBRN threat and remotely activates once or more decontamination measures as a precaution.

In addition to microcapsule technology, several other types of decontamination, containment, and filtration are known in the art, and can be incorporated into the systems, methods, and devices described herein in part or in whole, including in many different combinations depending on the design of the system and/or the anticipated threats to be encountered.

It should be noted that this same technology can be used in collective protection systems by incorporating self-detecting and/or self-decontaminating systems into air handling systems, building sensors, protective coverings for capital equipment or vehicles, or a number of other possible systems.

According to one embodiment is a method for detection and decontamination of a target hazard, such as a chemical, biological, radiological, and/or nuclear hazard. At step 300, the user wears, holds, or otherwise employs article 100 in a location where detection of a hazard is desirable. As just one example, step 300 could comprise a haz-mat worker wearing a detection/decontamination shirt or other article of clothing in a location where a hazard is suspected or possible. Many other articles are possible, as described above. As an alternative example, step 300 could comprise a user with detection/decontamination gloves or hat in a location where a hazard is suspected or possible. Article 100 employed in the method is previously functionalized and prepared according to methods described above, and can comprise, for example, a controller chip as well as a wireless transceiver or transmitter for notification purposes. Article 100 used in method 300 can comprise a detection sensor for target hazards. For example, the sensor can be any size depending on the requirements of the system, and can be distributed throughout the fabric or placed in a single location of the shirt. Further, there can be anywhere from one sensor to hundreds or thousands of sensors located in or on the shirt.

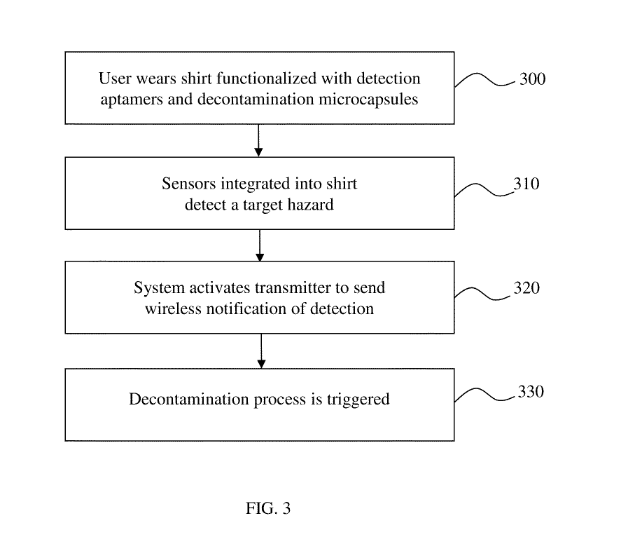

At step 310 of the method in FIG. 3, one or more of the sensors functionalized to the article—such as aptamers described above—detect a target hazard and send a signal to the controller chip. In one embodiment, binding of a target CBRN hazard will result in a specific electrical change. The specific electrical change, in turn, can be used to trigger a specific notification and/or decontamination. In this way, the system can detect, alert, and decontamination in response to individual CBRN threats.

At step 320, if a detection threshold is satisfied or surmounted, controller chip sends a signal to a transmitter, also integrated into article 100, inducing the transmitter to send a signal to a receiver that a detection event has occurred. Other information, including the specific threat detected, or quantitative information, can be included in the wireless signal. Additionally and/or alternatively, the system can be designed to specifically alert the user at/before/after step 320 of the method. As one example, the system can be designed to send a blue signal when a chemical agent is detected. As another example, the system can be set up to audibly announce the CBRN agent detected, such as triggering a speaker to say the words “ALERT, RADIATION DETECTED” when the system detects radiation.

At step 330 of the method, the system triggers a decontamination process in response to detection of a target CBRN threat. For example, once the threat is sensed, the controller means, such as controller chip 200 or other logic device or microprocessor, activates a secondary system to activate microcapsules containing decontaminating agents. In one embodiment, decontamination microcapsules 140, shown in FIG. 1, are embedded in or on the shirt worn by the haz-mat worker in this particular example. These microcapsules can be formed of, for example, organic materials, such as polymeric species, or inorganic materials, such as oxides, although this list is not meant to be comprehensive. There are a wide variety of microencapsulation methods and techniques, and any one of these methods may be used to create, or encapsulate material to form, microcapsules. Further, the clothing, tool, item, or external device may comprise just one type of microcapsule, or comprise many different types of microcapsules. A system designed to decontaminate multiple threats may contain many types of decontamination agents. In addition to microcapsule technology, several other types of decontamination, containment, and filtration are known in the art, and can be incorporated into the systems, methods, and devices described herein in part or in whole, including in many different combinations depending on the design of the system and/or the anticipated threats to be encountered.

Although the present invention has been described in connection with a preferred embodiment, it should be understood that modifications, alterations, and additions can be made to the invention without departing from the scope of the invention as defined by the claims.

What is claimed is:

1. A method of detecting a target in a sample using an article held or worn by a user, the method comprising the steps of:
contacting the article with the sample, the article comprising a target sensor and a decontamination element, wherein said target sensor comprises a plurality of aptamers functionalized to a conductive surface, and wherein said target sensor is in communication with said decontamination element;
detecting, by said target sensor, the target in said sample;
generating, by said target sensor, a detection notification signal in response to detection of said target in said sample;
activating the decontamination element in response to said notification signal; and
decontaminating, by activation of said decontamination element, said detected target.

2. The method of claim 1, wherein said conductive surface is a conductive fiber strand.

3. The method of claim 1, wherein said conductive surface is a fiber coated at least partially in metal.

4. The method of claim 1, wherein said plurality of aptamers form part of a conductive hydrogel.

5. The method of claim 1, wherein an electrical property of said hydrogel changes in response to detection of said target in said sample.

6. The method of claim 1, wherein said target is a chemical, biological, or radiological agent.

7. The method of claim 1, wherein said article further comprises a transmitter in communication with said target sensor.

8. The method of claim 7, further comprising the step of:
transmitting said detection notification signal in response to detection of said target in said sample.

9. The method of claim 1, wherein said article is an article of clothing.

10. The method of claim 1, wherein said article is a handheld device.

11. The method of claim 1, wherein said article comprises a plurality of different types of target sensors and a plurality of different types of decontamination elements, each of said plurality of different types of target sensors in communication with a corresponding different type of decontamination element.

12. The method of claim 11, wherein each different type of target sensor generates a unique detection notification signal.

13. The method of claim 11, wherein each unique detection notification signal activates a type of decontamination element corresponding to said unique detection notification signal.

14. A system for detecting a target in a sample using an article held or worn by a user, the system comprising:
a sample, said sample potentially comprising said target; and
an article, the article comprising a microprocessor, a target sensor, and a decontamination element, wherein said microprocessor, said target sensor, and said decontamination element are in communication, and wherein said target sensor comprises a plurality of aptamers functionalized to a conductive surface;
wherein said target sensor is adapted to detect a target in said sample, if said target is present in said sample, and where said target sensor is further adapted to generate a detection notification signal in response to detection of said target in said sample;
wherein said microprocessor is adapted to receive the generated detection notification signal and, in response to said received detection notification signal, activate the decontamination element;
wherein said activated decontamination element decontaminates said detected target.

15. The system of claim 14, wherein said conductive surface is a conductive fiber strand.

16. The system of claim 14, wherein said conductive surface is a fiber coated at least partially in metal.

17. The system of claim 14, wherein said plurality of aptamers form part of a conductive hydrogel.

18. The system of claim 14, wherein an electrical property of said hydrogel changes in response to detection of said target in said sample.

19. The system of claim 14, wherein said target is a chemical, biological, or radiological agent.

20. The system of claim 14, wherein said system further comprises:
a transmitter in communication with said microprocessor.

21. The system of claim 20, wherein said microprocessor is adapted to send a transmission signal to said transmitter in response to said received detection notification signal, and further wherein said transmitter is adapted to transmit an alert in response to the transmission signal.

22. The system of claim 20, wherein said transmitter is adapted to wirelessly transmit said alert.

23. The system of claim 11, wherein said article is an article of clothing.

24. The system of claim 11, wherein said article is a handheld device.

25. The system of claim 11, wherein said article comprises a plurality of different types of target sensors and a plurality of different types of decontamination elements.

26. The system of claim 25, wherein each different type of target sensor is adapted to generate a unique detection notification signal.

27. The system of claim 26, wherein each unique detection notification signal activates a type of decontamination element corresponding to said unique detection notification signal.

28. The system of claim 14, wherein the target sensor comprises one or more aptamers functionalized to a conductive surface.

29. A system for detecting a target in a sample using an article held or worn by a user, the system comprising:
a sample, said sample potentially comprising said target; and
an article, the article comprising a microprocessor, a target sensor, a decontamination element, and a wireless transmitter, wherein said microprocessor, said target sensor, said decontamination element, and said transmitter are in communication, and wherein said target sensor comprises a plurality of aptamers functionalized to a conductive surface;
wherein said target sensor is adapted to detect a target in said sample, if said target is present in said sample, and wherein said target sensor is further adapted to generate a detection notification signal in response to detection of said target in said sample, and further wherein the target sensor comprises one or more aptamers functionalized to a conductive surface;
wherein said microprocessor is adapted to receive the generated detection notification signal and, in response to said received detection notification signal, activate the decontamination element;
wherein said activated decontamination element decontaminates said detected target;
wherein said microprocessor is further adapted to send a transmission signal to said wireless transmitter in response to said received detection notification signal, and further wherein said wireless transmitter is adapted to transmit an alert in response to the transmission signal.

30. The system of claim 29, wherein said article is an article of clothing.

31. The system of claim 29, wherein said article is a handheld device.
